(19) United States
(12) Patent Application Publication
(10) Pub. No.: US 2026/0360331 A1
(43) Pub. Date: Nov. 12, 2026

(54) DUAL VIEW DISPLAY DEVICE AND DRIVING METHOD THEREOF

(71) Applicant: AUO Corporation, sinchu City (TW)

(72) Inventors: Zi-Jie XU, Hsinchu City (TW); Woei-Chyuan YANG, Hsinchu City (TW); Yen-Hua LO, Hsinchu City (TW)

(21) Appl. No.: 19/371,598

(22) Filed: Oct. 28, 2025

(30) Foreign Application Priority Data
May 7, 2025 (TW) 114117208

(51) Int. Cl. G09G 3/36

(52) U.S. Cl. CPC G09G 3/3688; G09G 3/3677; G09G 2300/0426; G09G 2310/08; G09G 2320/068

(57) ABSTRACT

A dual view display device includes a display panel and a source driving module. The display panel includes a plurality of sub-pixels and a plurality of data lines. The data lines are coupled to the sub-pixels. The data lines include a plurality of first data lines and a plurality of second data lines, which are alternately arranged. The source driving module is coupled to the display panel. The source driving module respectively transmits a plurality of first data signals corresponding to a first image to the first data lines, and respectively transmits a plurality of second data signals corresponding to a second image to the second data lines, so that the display panel displays the first image viewed at a first viewing angle based on the first data signals, and displays the second image viewed at a second viewing angle based on the second data signals.

### RELATED APPLICATIONS

This application claims priority to Taiwan Application Serial Number 114117208, filed May 07, 2025, which is herein incorporated by reference.

### BACKGROUND

### Technical Field

The present disclosure relates to a display device and a driving method thereof, and in particular, to a dual view display device and a driving method thereof.

### Description of Related Art

With the continuous advancement of technology, in certain situations, display devices are required to provide multiple images to meet requirements. For example, liquid crystal display devices currently widely used in on-board equipment can, on the one hand, display information images of a global positioning system (GPS) for a driver to view, and on the other hand, provide multimedia images for passengers for entertainment. The main principle for allowing the driver and passengers to view different images is to enable the display device to display different images for different viewing angles.

However, before inputting image data to existing display devices, the procedure of performing image preprocessing on two images in advance is required, to cross-mix two different images into a mixed image in order to enable a single panel to provide two different display contents, which not only consumes additional system resources, but also increases the time to present pictures. Hence, currently, the market lacks a display device capable of instantly and independently fulfilling two different display requirements. As a result, industry stakeholders are actively seeking viable solutions.

### SUMMARY

Therefore, the present disclosure provides a dual view display device, including a display panel and a source driving module. The display panel includes a plurality of sub-pixels and a plurality of data lines. The sub-pixels are arranged in an array. The data lines are coupled to the sub-pixels. The data lines include a plurality of first data lines and a plurality of second data lines, and the first data lines and the second data lines are alternately arranged. The source driving module is coupled to the display panel. The source driving module is configured to respectively transmit a plurality of first data signals corresponding to a first image to the first data lines, and respectively transmit a plurality of second data signals corresponding to a second image to the second data lines, so that the display panel displays the first image viewed at a first viewing angle based on the first data signals, and displays the second image viewed at a second viewing angle based on the second data signals.

The present disclosure relates to a driving method of a dual view display device, for driving the dual view display device. The dual view display device includes a display panel and a source driving module. The display panel includes a plurality of sub-pixels and a plurality of data lines. The driving method of the dual view display device includes transmitting, by a source driving module, a plurality of first data signals corresponding to a first image to a plurality of first data lines in the data lines, respectively; transmitting, by the source driving module, a plurality of second data signals corresponding to a second image to a plurality of second data lines in the data lines, respectively, wherein the first data lines and the second data lines are alternately arranged; and displaying, by the display panel, the first image viewed at a first viewing angle based on the first data signals, and the second image viewed at a second viewing angle based on the second data signals.

### BRIEF DESCRIPTION OF THE DRAWINGS

To make the above and other objects, features, advantages, and embodiments of the present disclosure more accessible and easier to understand, the accompanying drawings are described as follows:

FIG. 1 is a schematic diagram of a dual view display device according to a first embodiment of the present disclosure.

FIG. 2 is a cross-sectional view of the dual view display device according to FIG. 1.

FIG. 3A is a schematic diagram of the dual view display device according to FIG. 1 viewed at a first viewing angle.

FIG. 3B is a schematic diagram of the dual view display device according to FIG. 1 viewed at a second viewing angle.

FIG. 4 is a schematic diagram of a dual view display device according to a second embodiment of the present disclosure.

FIG. 5 is a cross-sectional view of the dual view display device according to FIG. 4.

FIG. 6A is a schematic diagram of the dual view display device according to FIG. 4 viewed at a first viewing angle.

FIG. 6B is a schematic diagram of the dual view display device according to FIG. 4 viewed at a second viewing angle.

FIG. 7 is a schematic diagram of a dual view display device according to a third embodiment of the present disclosure.

FIG. 8 is a flow chart of a driving method of a dual view display device according to a fourth embodiment of the present disclosure.

### DETAILED DESCRIPTION

The following disclosure provides many different embodiments or examples, for implementing different features of the provided inventions. Embodiments of components and configurations described below are merely examples, and are not intended to be limiting. Furthermore, for the sake of simplicity and clarity, the present disclosure repeats reference symbols and/or numbers throughout the examples, and this does not in itself limit the relationships between the various embodiments and/or components discussed.

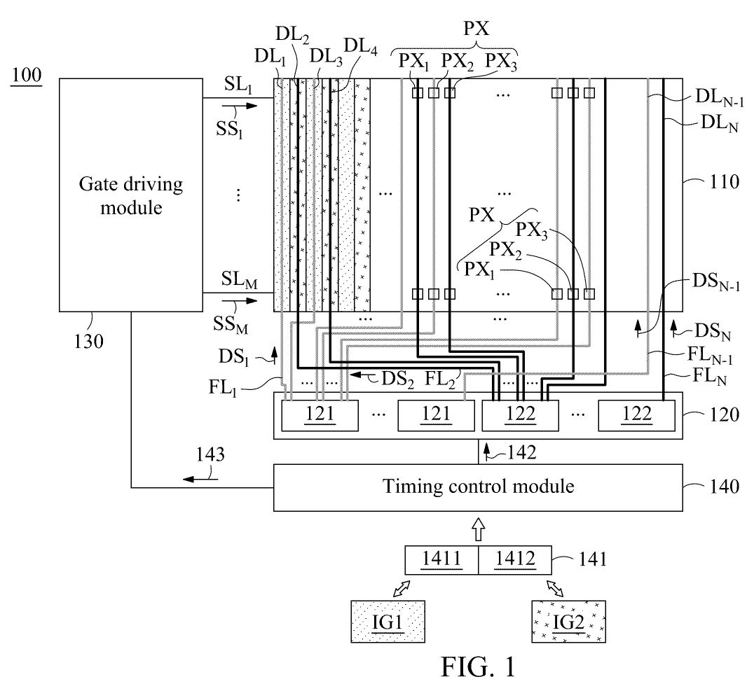

Reference is made to FIG. 1, which is a schematic diagram of a dual view display device 100 according to a first embodiment of the present disclosure. As shown in FIG. 1, the dual view display device 100 can be configured to provide a user with a first image IG1 and a second image IG2 viewed from a first viewing angle and a second viewing angle, respectively, and includes a display panel 110, a source driving module 120, and a gate driving module 130.

The display panel 110 can be, but is not limited to, a liquid crystal display panel in a liquid crystal display (LCD). The display panel 110 includes a pixel array, a plurality of data lines, and a plurality of scanning lines SL₁-SL_{M}, wherein M is a positive integer greater than 1. The pixel array is composed of a plurality of pixels PX. For the sake of clarity, only some of the pixels PX are labeled in FIG. 1 to represent all pixels PX. Other components (such as the data lines and the scanning lines SL₁-SL_{M}) are similarly described.

In the first embodiment, the pixels PX are arranged in an array. Each of the pixels PX can include a plurality of sub-pixels, and the sub-pixels in the display panel 110 are also arranged in an array. The sub-pixels include liquid crystals and can be simplified as a circuit consisting of a transistor, a storage capacitor, and a liquid crystal capacitor. The transistor can be a switch element, such as a thin-film transistor (TFT). Specifically, the sub-pixels in each of the pixels PX can be respectively a first sub-pixel PX₁, a second sub-pixel PX₂, and a third sub-pixel PX₃, and are configured to respectively display a first color, a second color, and a third color, wherein the first color, the second color, and the third color are different from each other. The data lines are coupled to a plurality of first sub-pixels PX₁, a plurality of second sub-pixels PX₂, and a plurality of third sub-pixels PX₃ in the pixels PX, and the scanning lines SL₁-SL_{M} are coupled to the first sub-pixels PX₁, the second sub-pixels PX₂, and the third sub-pixels PX₃ in the pixels PX. The data lines are sequentially labeled DL₁, DL₂, DL₃, DL₄…, DL_{N-1}, DL_{N} from left to right in FIG. 1, and include a plurality of first data lines DL₁, DL₃…DL_{N-1} and a plurality of second data lines DL₂, DL₄…DL_{N}, wherein N can be an even number greater than 1. Each of the first data lines DL₁, DL₃…DL_{N-1} and each of the second data lines DL₂, DL₄…DL_{N} are alternately arranged. In some embodiments, the first data lines DL₁, DL₃…DL_{N-1} can be an odd number of data lines, and the second data lines DL₂, DL₄…DL_{N} can be an even number of data lines. The first data lines DL₁, DL₃…DL_{N-1} and the second data lines DL₂, DL₄…DL_{N} are alternately arranged in an odd-even mode.

The source driving module 120 is coupled to the display panel 110. The source driving module 120 is configured to respectively transmit a plurality of first data signals DS₁-DS_{N-1} corresponding to the first image IG1 to the first data lines DL₁, DL₃…DL_{N-1}, and respectively transmit a plurality of second data signals DS₂-DS_{N} corresponding to the second image IG2 to the second data lines DL₂, DL₄…DL_{N}, wherein DS₁-DS_{N-1} are odd-numbered labels, and DL₂, DL₄…DL_{N} are even-numbered labels.

The gate driving module 130 is coupled to the display panel 110. The gate driving module 130 is configured to respectively transmit a plurality of scanning signals SS₁-SS_{M} to the scanning lines SL₁-SL_{M}. For the sake of clarity, only the first data signal DS₁ and the first data signal DS_{N-1} are labeled in FIG. 1 to represent all first data signals DS₁-DS_{N-1}, and the scanning signals SS₁-SS_{M} are similarly described. Specifically, each of the first sub-pixel PX₁, the second sub-pixel PX₂, and the third sub-pixel PX₃ is electrically connected to one of the scanning lines SL₁-SL_{M} and one of the data lines. The transistors in the sub-pixels are turned on by the corresponding scanning signals SS₁-SS_{M} to determine scanning. In the determining phase, the sub-pixels are driven by the corresponding first data signals DS₁-DS_{N-1} and second data signals DS₂-DS_{N} according to pictures desired by a user, so that the display panel 110 displays the first image IG1 viewed at the first viewing angle based on the first data signals DS₁-DS_{N-1}, and displays the second image IG2 viewed at the second viewing angle based on the second data signals DS₂-DS_{N}.

Thus, a wiring configuration of the dual view display device 100 of the present disclosure in which the first data signals DS₁-DS_{N-1} corresponding to the first image IG1 are received via the first data lines DL₁, DL₃…DL_{N-1}, and the second data signals DS₂-DS_{N} corresponding to the second image IG2 are received via the second data lines DL₂, DL₄…DL_{N} can achieve the signal interleaving function and instantly combine two different images without requiring the procedure of performing image preprocessing on two different images in advance. Therefore, when the user is positioned on either side of the dual view display device 100, the dual view display device 100 can instantly and independently meet the display requirements of the first viewing angle (e.g., a left viewing angle) and the second viewing angle (e.g., a right viewing angle).

Furthermore, the dual view display device 100 of the present disclosure can further include a timing control module 140. The timing control module 140 is electrically connected to an external controller (not shown), the source driving module 120, and the gate driving module 130. In some embodiments, the timing control module 140 can be, but is not limited to, a timing controller (TCON), and includes a processing unit and a storage unit electrically connected thereto. The timing control module 140 can be configured to receive combined image data 141 from the external controller and store same in the storage unit. The processing unit of the timing control module 140 generates a source driving control signal 142 based on the combined image data 141. The timing control module 140 transmits the source driving control signal 142 to the source driving module 120, so that the source driving module 120 sequentially generates and outputs the first data signals DS₁-DS_{N-1} and the second data signals DS₂-DS_{N} according to the source driving control signal 142, and transmits same to the corresponding first data lines DL₁, DL₃…DL_{N-1} and second data lines DL₂, DL₄…DL_{N}.

It is worth noting that the combined image data 141 can include a first image data 1411 for displaying the first image IG1 and a second image data 1412 for displaying the second image IG2. The second image data 1412 follows the first image data 1411 in sequence. In other embodiments, the timing control module 140 can also separately receive the first image data 1411 and the second image data 1412 from the external controller and store same in the storage unit, and the processing unit directly generates the source driving control signal 142 based on the first image data 1411 and the second image data 1412. Whether directly obtaining the combined image data 141 or separately obtaining the first image data 1411 and the second image data 1412, the timing control module 140 does not need to perform interleaved and mixed image preprocessing. The dual view display device 100 of the present disclosure can allow a single panel to provide users at different viewing angles with different images, only by utilizing a signal interleaving configuration within the display panel 110.

In addition, the processing unit of the timing control module 140 can also be configured to receive a control instruction from the external controller and generate a gate driving control signal 143 according to the control instruction. The gate driving control signal 143 can be, but is not limited to, a data latch enable (DLE) signal, a start pulse signal, or an output enable signal. The gate driving module 130 is configured to receive the gate driving control signal 143 from the timing control module 140 and respectively transmit the scanning signals SS₁-SS_{M} to the corresponding scanning lines SL₁-SL_{M} according to the gate driving control signal 143, thereby sequentially enabling the scanning lines SL₁-SL_{M}.

In some embodiments, the source driving module 120 can include a plurality of first source driving chips 121 and a plurality of second source driving chips 122. Each of the first source driving chips 121 includes a plurality of first pins, and the first pins are configured to respectively transmit a portion of the first data signals DS₁-DS_{N-1} to a portion of the corresponding first data lines DL₁, DL₃…DL_{N-1}. Each of the second source driving chips 122 includes a plurality of second pins, and the second pins are configured to respectively transmit a portion of the second data signals DS₂-DS_{N} to a portion of the corresponding second data lines DL₂, DL₄…DL_{N}. The number of first source driving chips 121 can be, for example, eight, and the number of second source driving chips 122 can be, for example, eight; however, the present disclosure is not limited thereto.

In some embodiments, the dual view display device 100 can further include a plurality of first fan-out wires FL₁-FL_{N-1} and a plurality of second fan-out wires FL₂-FL_{N}, wherein FL₁-FL_{N-1} are odd-numbered labels, and FL₂-FL_{N} are even-numbered labels. For the sake of clarity, only the first fan-out wire FL₁ and the first fan-out wire FL_{N-1}are labeled in FIG. 1 to represent all the first fan-out wires FL₁-FL_{N-1}, and the second fan-out wires FL₂-FL_{N} are similarly described.

One end of each of the first fan-out wires FL₁-FL_{N-1} is electrically connected to the first data lines DL₁, DL₃…DL_{N-1}, respectively. The other end of each of the first fan-out wires FL₁-FL_{N-1}is electrically connected to the first pins of all first source driving chips 121 in the source driving module 120, so that the source driving module 120 respectively transmits the first data signals DS₁-DS_{N-1} to the corresponding first data lines DL₁, DL₃…DL_{N-1} via the first fan-out wires FL₁-FL_{N-1}. One end of each of the second fan-out wires FL₂-FL_{N} is electrically connected to the second data lines DL₂, DL₄…DL_{N}, respectively. The other end of each of the second fan-out wires FL₂-FL_{N} is electrically connected to the second pins of all second source driving chips 122 in the source driving module 120, so that the source driving module 120 respectively transmits the second data signals DS₂-DS_{N} to the corresponding second data lines DL₂, DL₄…DL_{N} via the second fan-out wires FL₂-FL_{N}. Specifically, each of the second fan-out wires FL₂-FL_{N} is located on the same layer. To prevent collision between the first fan-out wires FL₁-FL_{N-1} and the second fan-out wires FL₂-FL_{N}, the first fan-out wires FL₁-FL_{N-1} can be routed to other layers (e.g., detouring to an upper or lower layer), avoiding the second fan-out wires FL₂-FL_{N}. Thus, the dual view display device 100 of the present disclosure can connect the first source driving chips 121 and the second source driving chips 122 in the source driving module 120 to the alternately arranged first data lines DL₁, DL₃…DL_{N-1} and second data lines DL₂, DL₄…DL_{N} via the first fan-out wires FL₁-FL_{N-1}and the second fan-out wires FL₂-FL_{N}, to achieve the signal interleaving function and instantly combine two different images without requiring the procedure of performing image preprocessing on two different images in advance.

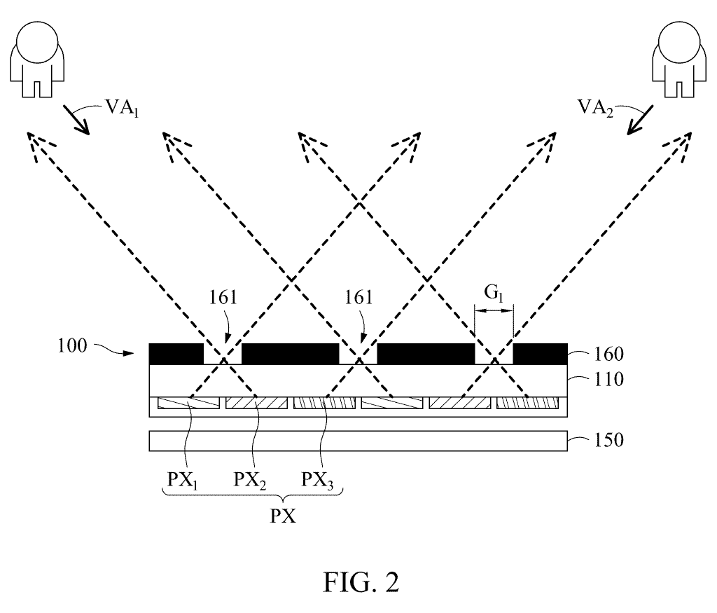

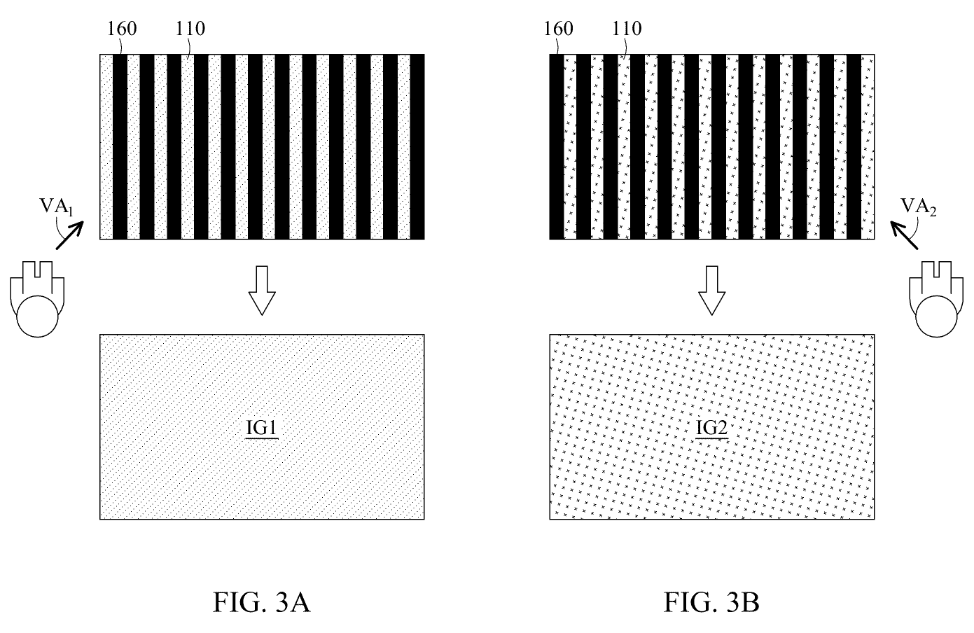

Referring to FIGS. 1, 2, 3A and 3B, FIG. 2 is a cross-sectional view of the dual view display device 100 according to FIG. 1, FIG. 3A is a schematic diagram of the dual view display device 100 according to FIG. 1 viewed at a first viewing angle VA₁, and FIG. 3B is a schematic diagram of the dual view display device 100 according to FIG. 1 viewed at a second viewing angle VA₂. As shown in FIGS. 1-3B, the dual view display device 100 can further include a backlight module 150 and a barrier plate 160. The backlight module 150 is located below the display panel 110 and provides light to the display panel 110. The barrier plate 160 is disposed on the display panel 110 and includes a plurality of openings 161 arranged in intervals. The openings 161 are configured to allow the light that has penetrated the display panel 110 to pass through. In the first embodiment, a spacing distance G₁ is defined between each two of the openings 161, and the spacing distance G₁ is measured in units of a sub-pixel size.

The light penetrating one of the first sub-pixel PX₁, the second sub-pixel PX₂, and the third sub-pixel PX₃ can be emitted from one of the openings 161 at a specific angle, while the remaining light is blocked by the barrier plate 160. Therefore, when the user views the display panel 110 at the first viewing angle VA₁ (e.g., the left viewing angle), since only light emitted toward the first viewing angle VA₁ (i.e., corresponding to the first data lines DL₁, DL₃…DL_{N-1} configured to receive the first data signals DS₁-DS_{N-1}) is visible to the user, the display panel 110 can display the first image IG1 to the user. On the contrary, when the user views the display panel 110 at the second viewing angle VA₂ (e.g., the right viewing angle), since only light emitted toward the second viewing angle VA₂ (i.e., corresponding to the second data lines DL₂, DL₄…DL_{N} configured to receive the second data signals DS₂-DS_{N}) is visible to the user, the display panel 110 can display the second image IG2 to the user. Thus, the dual view display device 100 of the present disclosure not only utilizes the signal interleaving function within the panel, but also utilizes the opening configuration of the barrier plate 160 to allow a single panel to input two different image data, thereby allowing users at different viewing angles to view different images.

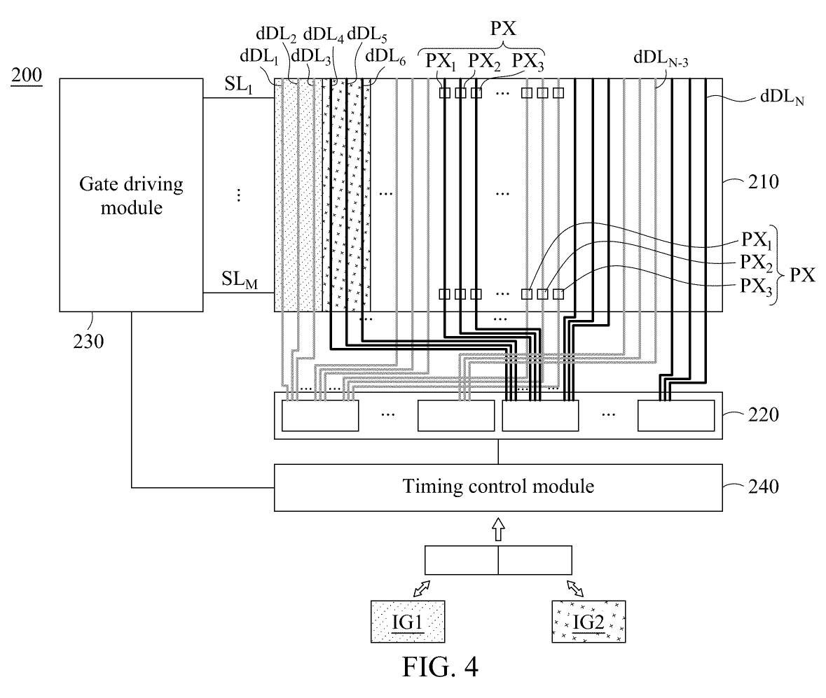

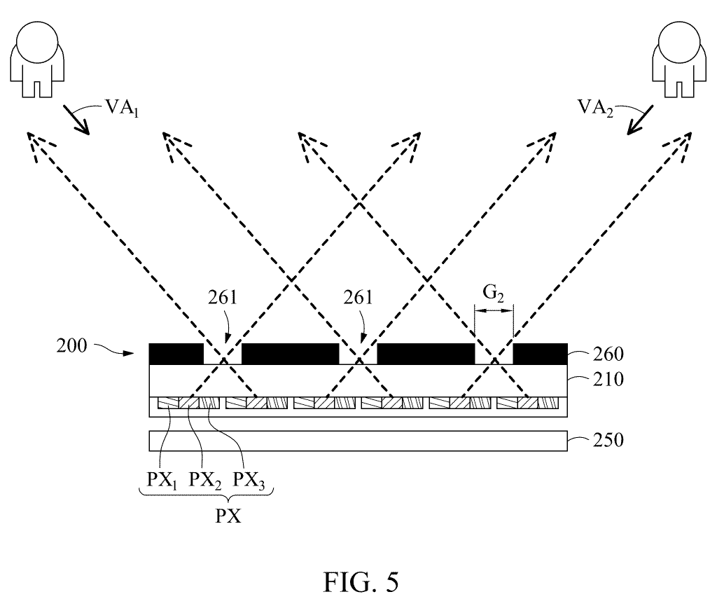

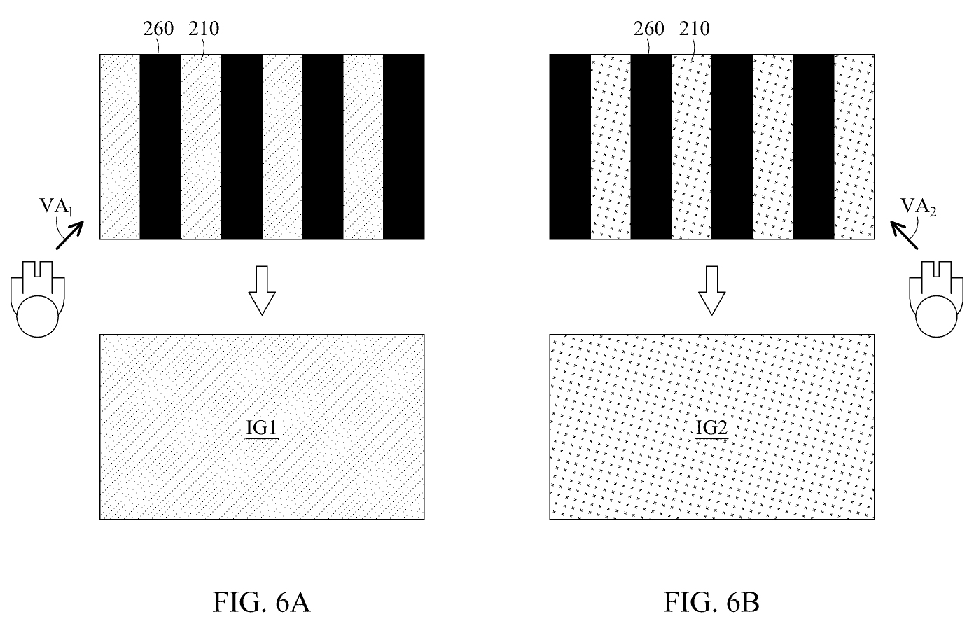

Referring to FIGS. 4, 5, 6A and 6B, FIG. 4 is a schematic diagram of a dual view display device 200 according to a second embodiment of the present disclosure, FIG. 5 is a cross-sectional view of the dual view display device 200 according to FIG. 4, FIG. 6A is a schematic diagram of the dual view display device 200 according to FIG. 4 viewed at a first viewing angle VA₁, and FIG. 6B is a schematic diagram of the dual view display device 200 according to FIG. 4 viewed at a second viewing angle VA₂. As shown in FIGS. 4-6B, the dual view display device 200 can be configured to provide a user with a first image IG1 and a second image IG2 viewed at the first viewing angle VA₁ and the second viewing angle VA₂, respectively, and includes a display panel 210, a source driving module 220, a gate driving module 230, a timing control module 240, a backlight module 250, and a barrier plate 260. The dual view display device 200 is similar to the dual view display device 100 of the first embodiment.

The difference lies in that a plurality of data lines of the display panel 210 are sequentially labeled dDL₁, dDL₂, dDL₃, dDL₄, dDL₅, dDL₆…dDL_{N} from left to right in FIG. 4, and include a plurality of first data lines dDL₁, dDL₂, dDL₃…dDL_{N-3} and a plurality of second data lines dDL₄, dDL₅, dDL₆…dDL_{N}, wherein N can be an integer greater than 3. It is worth noting that every three of the first data lines dDL₁, dDL₂, dDL₃…dDL_{N-3} and every three of the second data lines dDL₄, dDL₅, dDL₆…dDL_{N} are alternately arranged. The first data lines dDL₁, dDL₂, dDL₃…dDL_{N-3} are configured to respectively receive a plurality of first data signals (not separately labeled) corresponding to the first image IG1 from the source driving module 220, and the second data lines dDL₄, dDL₅, dDL₆…dDL_{N} are configured to respectively receive a plurality of second data signals (not separately labeled) corresponding to the second image IG2 from the source driving module 220.

Furthermore, a spacing distance G₂ is defined between each two of the plurality of openings 261, and the spacing distance G₂ is measured in units of a pixel size (i.e., the unit is the size of a single pixel PX). In other words, light simultaneously penetrating the first sub-pixel PX₁, the second sub-pixel PX₂, and the third sub-pixel PX₃can be emitted from one of the openings 261 at a specific angle, while the remaining light is blocked by the barrier plate 260. Therefore, when the user views the display panel 210 at the first viewing angle VA₁, since only light emitted toward the first viewing angle VA₁ (i.e., corresponding to the first data lines dDL₁, dDL₂, dDL₃…dDL_{N-3} configured to receive the first data signals) is visible to the user, the display panel 210 can display the first image IG1 to the user. On the contrary, when the user views the display panel 210 at the second viewing angle VA₂, since only light emitted toward the second viewing angle VA₂ (i.e., corresponding to the second data lines dDL₄, dDL₅, dDL₆…dDL_{N} configured to receive the second data signal) is visible to the user, the display panel 210 can display the second image IG2 to the user.

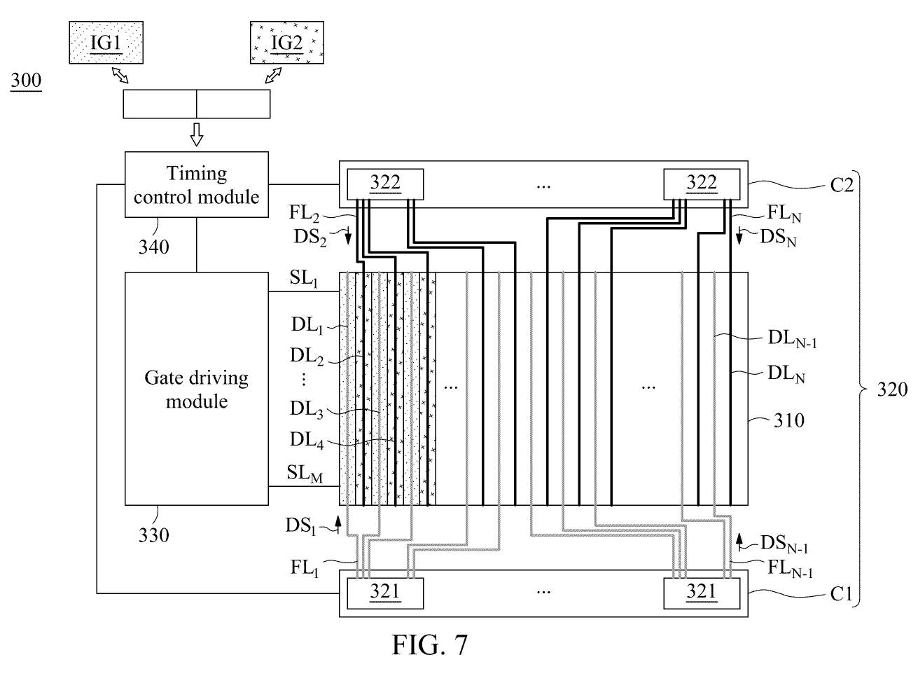

Reference is made to FIG. 7, which is a schematic diagram of a dual view display device 300 according to a third embodiment of the present disclosure. As shown in FIG. 7, the dual view display device 300 can be configured to provide a user with a first image IG1 and a second image IG2 viewed at different viewing angles, and includes a display panel 310, a source driving module 320, a gate driving module 330, a timing control module 340, a backlight module (not shown), and a barrier plate (not shown). In addition to the source driving module 320, the elements/modules are the same as the corresponding elements of the dual view display device 100 of the first embodiment.

The difference lies in that the source driving module 320 can include a first source driving circuit C1 and a second source driving circuit C2. The first source driving circuit C1 is coupled to the display panel 310 and located on one side of the display panel 310. The second source driving circuit C2 is coupled to the display panel 310 and located on the other side of the display panel 310. The first source driving circuit C1 includes a plurality of first source driving chips 321, and the second source driving circuit C2 includes a plurality of second source driving chips 322. The first source driving chips 321 in the first source driving circuit C1 can be configured to respectively transmit the first data signals DS₁-DS_{N-1} corresponding to the first image IG1 to the corresponding first data lines DL₁, DL₃…DL_{N-1}. The second source driving chips 322 in the second source driving circuit C2 can be configured to respectively transmit the second data signals DS₂-DS_{N} corresponding to the second image IG2 to the corresponding second data lines DL₂, DL₄…DL_{N}. In view of the above, since the configuration positions of the first source driving chips 321 and the second source driving chips 322 are different, the routing configurations of the first fan-out wires FL₁-FL_{N-1} and the second fan-out wires FL₂-FL_{N} are also adjusted accordingly. Furthermore, in the third embodiment, the first fan-out wires FL₁-FL_{N-1} and the second fan-out wires FL₂-FL_{N} can all be located on the same layer, there is no need to route to other layers (e.g., detouring to an upper or lower layer), avoiding line collisions.

The following description uses the driving method 400 of a dual view display device applied to the dual view display device 100 of the first embodiment as an example. However, in other embodiments, the driving method 400 of the dual view display device can also be applied to the dual view display devices 200, 300 of the second and third embodiments.

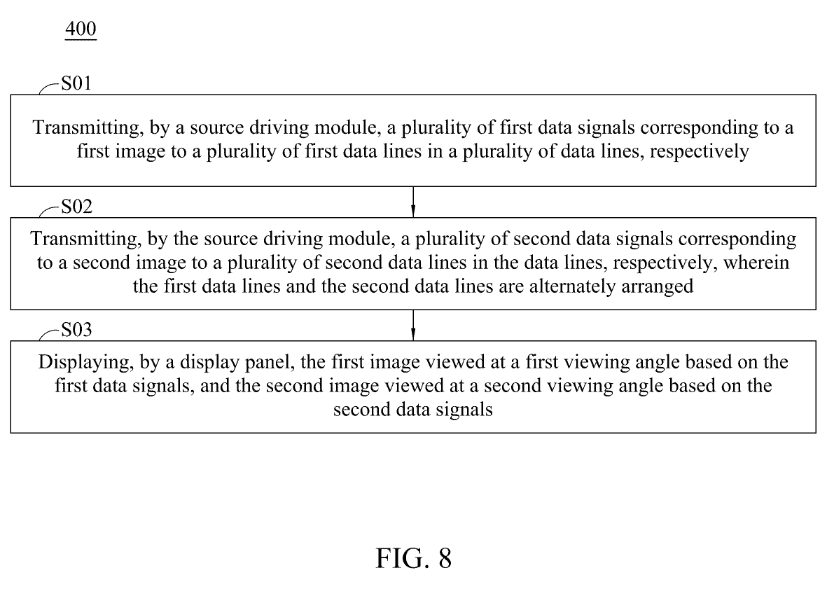

Referring to FIGS. 1-3A and 8, FIG. 8 is a flow chart of a driving method 400 of a dual view display device according to a fourth embodiment of the present disclosure. As shown in FIGS. 1-3A and 8, the driving method 400 of the dual view display device can be configured to drive the dual view display device 100 to provide the user with the first image IG1 and the second image IG2 viewed at the first viewing angle VA₁ and the second viewing angle VA₂, respectively. The driving method 400 of the dual view display device includes the following Steps S01, S02, S03, which are performed in sequence.

Step S01: transmitting, by a source driving module 120, a plurality of first data signals DS₁-DS_{N-1} corresponding to a first image IG1 to a plurality of first data lines DL₁, DL₃…DL_{N-1} in a plurality of data lines, respectively.

Step S02: transmitting, by the source driving module 120, a plurality of second data signals DS₂-DS_{N} corresponding to a second image IG2 to a plurality of second data lines DL₂, DL₄…DL_{N} in the data lines, respectively, wherein the first data lines DL₁, DL₃…DL_{N-1} and the second data lines DL₂, DL₄…DL_{N} are alternately arranged.

Step S03: displaying, by a display panel 110, the first image IG1 viewed at a first viewing angle VA₁based on the first data signals DL₁, DL₃…DL_{N-1}, and the second image IG2 viewed at a second viewing angle VA₂ based on the second data signals DS₂-DS_{N}.

In some embodiments, before performing Steps S01, S02, the driving method 400 of the dual view display device can further include: receiving, by a timing control module 140, a combined image data 141 and generating a source driving control signal 142 based on the combined image data 141; and transmitting, by the timing control module 140, the source driving control signal 142 to the source driving module 120, so that the source driving module 120 sequentially generates and outputs the first data signals DS₁-DS_{N-1} and the second data signals DS₂-DS_{N} according to the source driving control signal 142. In some embodiments, before performing Steps S01, S02, the driving method 400 for the dual view display device can further include: receiving, by a gate driving module 130, a gate driving control signal 143 from the timing control module 140, and respectively transmitting a plurality of scanning signals SS₁-SS_{M} to a plurality of scanning lines SL₁-SL_{M} of the display panel 110 according to the gate driving control signal 143, thereby sequentially enabling the scanning lines SL₁-SL_{M}.

According to the dual view display device and the driving method thereof of the present disclosure, the signal interleaving function can be achieved by grouping a plurality of data lines into a first data line group and a second data line group which are alternately arranged, and using same to respectively receive first data signals corresponding to a first image and second data signals corresponding to a second image. Furthermore, the present disclosure utilizes the opening configuration of a barrier plate to allow a single panel to input two different image data, thereby allowing users at different viewing angles to view different images. Accordingly, two different images can be instantly combined, without the need for interleaved and mixed image preprocessing of two different images, thereby rapidly and independently meet two different display requirements.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A dual view display device, comprising:
a display panel, comprising:
a plurality of sub-pixels, arranged in an array; and
a plurality of data lines, coupled to the sub-pixels and comprising a plurality of first data lines and a plurality of second data lines, wherein the first data lines and the second data lines are alternately arranged; and
a source driving module, coupled to the display panel and configured to respectively transmit a plurality of first data signals corresponding to a first image to the first data lines, and respectively transmit a plurality of second data signals corresponding to a second image to the second data lines, so that the display panel displays the first image viewed at a first viewing angle based on the first data signals, and displays the second image viewed at a second viewing angle based on the second data signals.

2. The dual view display device according to claim 1, further comprising:
a timing control module, electrically connected to the source driving module and configured to transmit a source driving control signal to the source driving module, so that the source driving module sequentially generates and outputs the first data signals and the second data signals according to the source driving control signal.

3. The dual view display device according to claim 2, wherein the timing control module is configured to receive a combined image data and generate the source driving control signal based on the combined image data, the combined image data comprises a first image data for displaying the first image and a second image data for displaying the second image, and the second image data follows the first image data in sequence.

4. The dual view display device according to claim 1, wherein the display panel further comprises a plurality of scanning lines coupled to the sub-pixels, and the dual view display device further comprises:
a gate driving module, coupled to the display panel and configured to receive a gate driving control signal and respectively transmit a plurality of scanning signals to the scanning lines according to the gate driving control signal.

5. The dual view display device according to claim 1, wherein the source driving module comprises:
a plurality of first source driving chips, wherein each of the first source driving chips comprises a plurality of first pins, and the first pins are configured to respectively transmit a portion of the first data signals to a portion of the first data lines; and
a plurality of second source driving chips, wherein each of the second source driving chips comprises a plurality of second pins, and the second pins are configured to respectively transmit a portion of the second data signals to a portion of the second data lines.

6. The dual view display device according to claim 1, further comprising:
a plurality of first fan-out wires, respectively electrically connected to the first data lines and electrically connected to the source driving module, so that the source driving module respectively transmits the first data signals to the first data lines via the first fan-out wires; and
a plurality of second fan-out wires, respectively electrically connected to the second data lines and electrically connected to the source driving module, so that the source driving module respectively transmits the second data signals to the second data lines via the second fan-out wires.

7. The dual view display device according to claim 1, wherein each of the first data lines and each of the second data lines are alternately arranged.

8. The dual view display device according to claim 1, wherein every three of the first data lines and every three of the second data lines are alternately arranged.

9. The dual view display device according to claim 1, further comprising:
a backlight module, located below the display panel and configured to provide a light to the display panel; and
a barrier plate, disposed on the display panel and comprising a plurality of openings arranged at intervals, wherein the openings are configured to allow the light that has penetrated the display panel to pass through.

10. The dual view display device according to claim 9, wherein a spacing distance is defined between each two of the openings, and the spacing distance is measured in units of a pixel size.

11. The dual view display device according to claim 9, wherein a spacing distance is defined between each two of the openings, and the spacing distance is measured in units of a sub-pixel size.

12. The dual view display device according to claim 1, wherein the source driving module comprises:
a first source driving circuit, coupled to the display panel and located on one side of the display panel, wherein the first source driving circuit is configured to respectively transmit the first data signals corresponding to the first image to the first data lines; and
a second source driving circuit, coupled to the display panel and located on the other side of the display panel, wherein the second source driving circuit is configured to respectively transmit the second data signals corresponding to the second image to the second data lines.

13. A driving method of a dual view display device, for driving the dual view display device, the dual view display device comprising a display panel and a source driving module, the display panel comprising a plurality of sub-pixels and a plurality of data lines, and the driving method of the dual view display device comprising:
transmitting, by the source driving module, a plurality of first data signals corresponding to a first image to a plurality of first data lines in the data lines, respectively;
transmitting, by the source driving module, a plurality of second data signals corresponding to a second image to a plurality of second data lines in the data lines, respectively, wherein the first data lines and the second data lines are alternately arranged; and
displaying, by the display panel, the first image viewed at a first viewing angle based on the first data signals, and the second image viewed at a second viewing angle based on the second data signals.

14. The driving method of the dual view display device according to claim 13, wherein before a step of transmitting the first data signals corresponding to the first image, the driving method of the dual view display device further comprises:
receiving, by a timing control module, a combined image data and generating a source driving control signal based on the combined image data, wherein the combined image data comprises a first image data for displaying the first image and a second image data for displaying the second image, and the second image data follows the first image data in sequence; and
transmitting, by the timing control module, the source driving control signal to the source driving module, so that the source driving module sequentially generates and outputs the first data signals and the second data signals according to the source driving control signal.

15. The driving method of the dual view display device according to claim 13, wherein before a step of transmitting the first data signals corresponding to the first image, the driving method of the dual view display device further comprises:
receiving, by a gate driving module, a gate driving control signal and respectively transmitting a plurality of scanning signals to a plurality of scanning lines of the display panel according to the gate driving control signal.

16. The driving method of the dual view display device according to claim 13, wherein the source driving module comprises a plurality of first source driving chips and a plurality of second source driving chips, each of the first source driving chips comprises a plurality of first pins, the first pins are configured to respectively transmit a portion of the first data signals to a portion of the first data lines, each of the second source driving chips comprises a plurality of second pins, and the second pins are configured to respectively transmit a portion of the second data signals to a portion of the second data lines.

17. The driving method of the dual view display device according to claim 13, wherein the source driving module respectively transmits the first data signals to the first data lines via a plurality of first fan-out wires, and respectively transmits the second data signals to the second data lines via a plurality of second fan-out wires.

18. The driving method of the dual view display device according to claim 13, wherein the source driving module comprises a first source driving circuit and a second source driving circuit, the first source driving circuit is configured to respectively transmit the first data signals corresponding to the first image to the first data lines, and the second source driving circuit is configured to respectively transmit the second data signals corresponding to the second image to the second data lines.
